(19) United States
(12) Patent Application Publication
(10) Pub. No.: US 2019/0160849 A1
(43) Pub. Date: May 30, 2019

(54) APPARATUS AND SYSTEM FOR KEEPING A COVER RELEASABLY SECURED OVER AN OPENING

(71) Applicant: Devin Michael Kain, Delong, WA (US)

(72) Inventor: Devin Michael Kain, Delong, WA (US)

(21) Appl. No.: 16/199,127

(22) Filed: Nov. 23, 2018

Related U.S. Application Data
(60) Provisional application No. 62/590,554, filed on Nov. 25, 2017.

(51) Int. Cl. B42D 3/10; B42D 3/12; B42D 3/08

(52) U.S. Cl. CPC B42D 3/10; G04B 37/04; B42D 3/08; B42D 3/12

(57) ABSTRACT

A cover is releasably secured over an opening by an apparatus or a fastener system and may be used in a book-clock system having a clock movement housed within a space hollowed through the book's pages. A clock shaft protruding from the movement passes through an opening in a fastening element and then through a hole in the book's front cover. The clock shaft supports and moves the clock hands on the front. The fastening element may be a flexible strip. It may be positioned in a U-shape about the clock movement so at least a ferromagnetic part of the fastening element is adjacent to portion of the clock movement facing the back cover. A magnet is positioned on the back cover so when closed, the magnet meets the ferromagnetic part of the fastening element. A magnetic force is exerted and releasably holds the back cover of the book closed.

### CROSS-REFERENCE TO RELATED APPLICATION

This application claims priority to and benefit of the prior filed co-pending and commonly owned provisional application filed in the United States Patent and Trademark Office on Nov. 25, 2017, assigned Ser. No. ______, entitled Method and Apparatus for Creating a Clock Housing, and incorporated herein by reference.

### FIELD OF THE INVENTION

The invention relates generally to apparatuses, devices, kits, and systems and methods of using same with respect to cases housing clock movements and/or the like in purpose or in size, and particularly, to books and/or the like used to store clock movements and/or the like and display the time.

### BACKGROUND

Recycling and repurposing used, non-functioning, and/or unwanted materials into new, useful and/or aesthetically pleasing combinations of products has been a fast growing area of interest among hobbyists, craft-persons, and artisans alike. According to some estimates, over two billion pounds of books are wasted and/or recycled into other products each year in the United States alone. Many of the aforementioned hobbyists, craft-persons, and artisans use books as an affordable and aesthetically pleasing medium for the creation of new products. Converting said books into clocks has been one such product that has been made popular recently. Besides books, other used, non-functioning, and/or unwanted items such as display cases, cigar boxes, shadow boxes, and picture frames also have been used for the creation of new products that may include a clock.

However, most of the solutions so far used to make the new products may be characterized as time-intensive, requiring a skilled hand, and incorporating materials that are uncommon. Some current solutions are not cost effective or time efficient. Even though some of the current solutions may be advertised or promoted as do-it-yourself (“DIY”) projects, these solutions may require using tools and methods that are not generally found in a household such as specialized hand tools including razors and precision utility/hobby knives, and/or messy and costly gluing methods. A person using one of these solutions may find that he or she has to invest unplanned time in acquiring the needed skills before being able to produce an acceptable end product. Thus, there is a general need for a way to convert used, non-functioning, and/or unwanted materials into new, useful and/or aesthetically pleasing combinations of products such as books displaying clocks.

There is a particular problem even among the professional converters of used, non-functioning, and/or unwanted materials into new, useful and/or aesthetically pleasing combinations of products. The particular problem is that in some cases the nature of the used, non-functioning, and/or unwanted material limits the use and display possibilities of the new combination product.

For example, assume a book is combined with appropriate clock elements into a book/clock unit. Current solutions may teach that the clock movement may be housed between the covers of the book with the front cover of the book serving as the face of the clock and displaying the hands of the clock. Current solutions, however, do not teach or suggest advantageous treatment of the back cover of the book/clock unit. One current solution is that the back cover may be sealed with respect to the rest of the book/clock unit. But sealing the back cover leaves the problems of how to change the clock battery, reset the time, or otherwise gain access to the interior of the book/clock unit. These problems decrease end-user ease of operation and limit display options. On the other hand, if the back cover is left loose from the book/clock unit, it may leave the interior of the book/clock unit open and prone to damage. A book/clock unit with a loose back cover may be difficult to display. If placed on a wall, the book/clock unit may pull away from wall. If stood on a table, the covers of the book/clock unit may pull apart and it may collapse or at least be rickety in its positioning on a table top.

Yet another problematic solution to the back cover of the book/clock unit is to cut at least part of the back cover away to provide access to the inside of the book/clock unit. Besides adding time, effort, and cost to the conversion project, cutting a hole in the back cover of the book/clock unit may limit its display options and still leave the interior of the book/clock unit vulnerable to damage. Thus, a there is a particular need for a way to address problems presented by the nature of the used, non-functioning, and/or unwanted material as it is converted into the new combination product such as the particular problem of the back book cover in a book/clock unit.

### SUMMARY

Stated generally, the invention relates to an apparatus or system for releasably securing a cover over an opening such as an opening into a container. “Releasably” means the cover may be secured over the opening, and then may be unsecured to uncover the opening.

The principles of the invention are described herein with reference to an exemplary embodiment in which a book is used as the container. The book is used as part of a book-clock system that includes a clock movement (also referred to as “clock motor”) housed within a space hollowed out of the pages of the book. A clock shaft is operationally connected to the clock movement and protrudes from the clock movement. The clock shaft passes through a hole in the front cover of the book where the clock shaft supports the clock hands and translates the operations of the clock movement to the clock hands. A fastener (also referred to as a “fastening element”) is positioned around at least part of the clock movement. For example, the fastener may be wrapped in a U-shape around the clock movement. One end of the fastener may include a hole through which the clock shaft passes before it passes through the front cover of the book. The other end of the fastener may be positioned adjacent to the back of the clock movement. The position of the fastener with respect to the back of the clock movement may be adjusted to accommodate for the difference between the size (depth) of the clock movement and the thickness (depth) of the pages of the book. A magnet is disposed on the back cover of the book and aligned so that when the back cover of the book is closed, the magnet may meet at least part of the fastener, which may be ferromagnetic in whole or in the part meeting the magnet. The magnetic force between the magnet and fastener holds the back cover of the book closed, but yet allows for the back cover of the book to be opened.

The invention and its embodiments may offer many advantages. A principal advantage is the interior of a container may be accessed by opening the cover and then may be closed by securing the cover. For example, it is advantageous to gain relatively easy access to the interior of the book-clock system for purposes of setting or re-setting the time, for switching out the batteries, etc. Another advantage is the container may be releasably closed so as to avoid contamination to the interior of the container.

An advantage offered by the invention and its embodiments may be the variety of display options made possible by releasably securing the cover over a container. For example, a book-clock system according to the invention may be displayed so it is free-standing on a table with its book covers closed or with the pages fanned out, or the book-clock system may be hung on a wall.

When the invention is embodied in a book-clock system, it may deliver several advantageous features and may offer advantages. A first advantage is that a book-clock system typically uses a book that has been discarded or is no longer wanted, and so the book may be recycled and repurposed into the book-clock system. Another advantage is the invention maintains the structural integrity of at least the front and back covers of a book used in the book-clock system, thereby also maintaining the aesthetically pleasing nature of the book as part of the book-clock system. Also, the pages of a book used in a book-clock system according to the invention do not have to be glued to each other, but may be left free to fan out such as when the book-clock system is displayed. Further, the invention allows books of varying thicknesses to be used as part of book-clock systems including thinner books that in the past were unavailable for use in such systems.

A first embodiment of the invention is a book-clock system that keeps the front cover and the back cover of a book selectively closed about the pages of the book. This embodiment may include a clock movement housed within a space hollowed through the pages of the book. A clock shaft is connected to the clock movement for moving clock hands according to the clock movement. The clock shaft protrudes from the clock movement for passing through a hole in the front cover of the book. The clock shaft supports the clock hands on the outside of the front cover of the book. A fastening element has an opening near one end for passing the clock shaft through the fastening element prior to the clock shaft being passed through the hole in the front cover of the book so the end of the fastening element with the opening is positioned between the front cover of the book and the clock movement. The fastening element may be supported between the front cover of the book and the clock movement at least in part by the clock shaft. The fastening element is positioned about the clock movement so at least a part of the fastening element is adjacent to a portion of the clock movement facing the back cover of the book. The fastening element may assume a U-shape about the clock movement. At least a part of the fastening element adjacent to the portion of the clock movement facing the back cover of the book is ferromagnetic. Alternatively, the fastening element may be substantially entirely ferromagnetic or may be a flexible ferromagnetic strip. A magnet is positioned on the back cover of the book so when the back cover is closed, the magnet meets the ferromagnetic part of the fastening element and a magnetic force is exerted between the magnet and the ferromagnetic part of the fastening element. Advantageously, the magnetic force between the magnet and the ferromagnetic part of the fastening element holds the back cover of the book closed unless the back cover of the book is opened forcibly enough to overcome the magnetic force.

A second embodiment of the invention provides an apparatus to releasably secure a cover over an opening in a container used to display time. A clock movement is housed inside the container with a clock shaft operationally connected to and protruding from the clock movement. The clock shaft passes through the container to an outside part of the container used as a clock face. The clock shaft supports the clock hands on the clock face. The clock shaft moves the clock hands according to the clock movement. The container has an opening to provide access to the clock movement. A ferromagnetic element is disposed in the access opening of the container. The ferromagnetic element may be a flexible ferromagnetic strip. A magnet is disposed on the cover so the magnet is aligned with the ferromagnetic element in the access opening of the container when the cover is placed over the access opening. An advantage of this embodiment is that the alignment of the magnet and the ferromagnetic element creates a magnetic force that releasably secures the cover over the access opening of the container.

A third embodiment of the invention provides a fastener system for releasably securing a cover over a container opening. The fastener system includes a ferromagnetic element disposed in the container opening, and a magnet positioned on the cover so the magnet meets the ferromagnetic element when the cover is closed over the container opening. Advantageously, closing the cover over the container opening creates a magnetic force between the magnet and the ferromagnetic element to releasably secure the cover over the container opening.

Other features and advantages of the invention may be more clearly understood and appreciated from a review of the following detailed description and by reference to the appended drawings and claims.

### BRIEF DESCRIPTION OF THE DRAWINGS

FIG. 1 illustrates a perspective view of an exemplary embodiment of the invention.

FIG. 2 illustrates a perspective view of an exemplary embodiment of the invention.

FIG. 3 illustrates an exploded view of an exemplary embodiment of the invention.

FIG. 4 illustrates a partial cutaway view of an exemplary embodiment of the invention.

FIG. 5 illustrates a perspective view of the interaction of elements of an exemplary embodiment of the invention.

### DETAILED DESCRIPTION

The invention is described herein with reference to exemplary embodiments, alternative embodiments, and also with reference to the attached drawings. The invention, however, may be embodied in many different forms and carried out in a variety of ways, and should not be construed as limited to the embodiments set forth herein. The exemplary embodiments that are described and shown herein are only examples of the ways to implement the invention. Others will occur to those skilled in the art.

In terms of nomenclature herein, the singular includes the plural, the masculine includes the feminine and/or neutral, a person includes a corporation, a partnership, any other organization of people or persons, (and/or the like), and an embodiment, in whole or in part, may be an apparatus, a device, a kit, a method, and/or a system, unless otherwise noted. Generally, the terms “and” and “or” may be interchangeable unless otherwise noted or understood from context. Moreover, like numerals indicate like elements throughout the figures.

Generally stated, the invention relates to an apparatus or system for releasably securing a cover over an opening such as an opening into a container. The term “releasably” is used to explain that the cover may be secured over the opening, and then may be unsecured, or in other words, opened to uncover the opening. In most embodiments, the acts of securing and of unsecuring may be repeated as often as necessary or desired.

The apparatus or system of the invention may be implemented in many different embodiments. As noted above, an embodiment of the invention may be used to cover an opening such as an opening into a container. The container may be any type of device that may be used typically to hold things such as a basket, a bowl, a box, a can, a canister, a hamper, a holder, a receptacle, a repository, a vessel, or the like. The container also may be any type of device suited to the purpose of the use of the container and that may not typically be used to hold things. Examples of the latter type of container may include a book that may be made to hold things such as by the removal of the pages or parts of the pages of the book or otherwise, or a container that may be made to look like a book (“faux book”).

Again as noted above, an embodiment of the invention may be used to cover an opening such as an opening into a container. An “opening” according to the invention may be any type of aperture or gap that allows a user's access such as access into the container or parts thereof.

The principles of the invention are described herein with reference to an exemplary embodiment in which a book is used as the container. In this exemplary embodiment, the book is used as part of a book-clock system that includes a clock movement housed within the book and that uses the front cover of the book as the face of the clock to display the hands of the clock. The invention, however, should not be limited to this exemplary embodiment of the book-clock system. Other embodiments are possible. For example, an embodiment may use a different container (such as a vase or a table lamp) to hold a clock movement, to display the clock hands on the exterior of the container, and to provide a way to releasably secure a cover giving access to the clock movement within the container. Yet other embodiments may fail to include a clock and simply provide a way to releasably secure a cover over an opening.

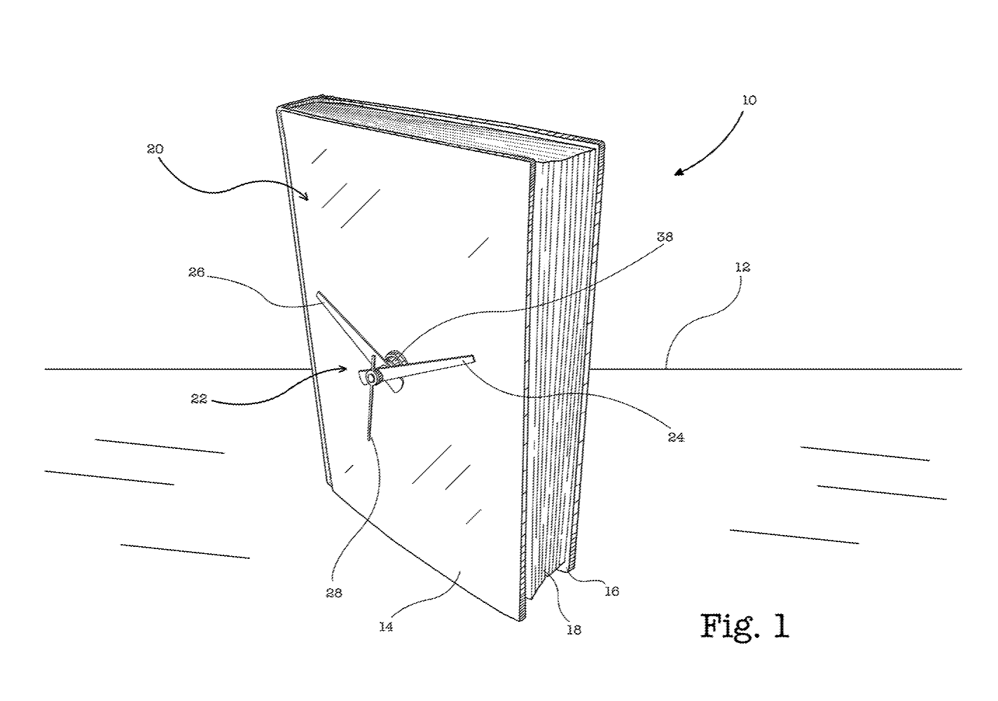

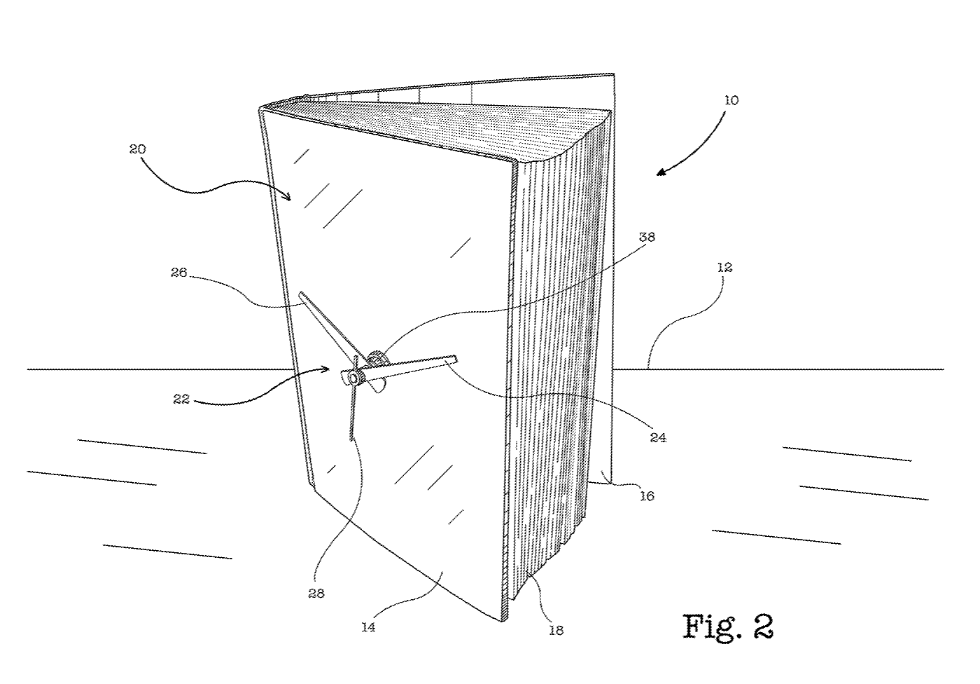

FIGS. 1 and 2 illustrate an exemplary embodiment 10 of the invention as a book-clock system 10 displayed on a table 12, or other relatively flat surface. Prior to this invention, such a book-clock configuration (absent the invention) may have been difficult to position in either the manner shown in FIG. 1 or 2. If the prior art book-clock configuration were displayed as shown in FIG. 1 in standing on its bottom side with both book covers closed, the prior art book-clock configuration may have been prone to toppling over (depending on the book) because the front or back cover(s) of the book in the configuration may have tried to open away from the pages of the book, thereby toppling the configuration. If the prior art book-clock configuration were displayed as shown in FIG. 2 in standing with its back cover of the book open and at least some of the pages fanned towards the back cover, the prior art book-clock configuration also may have been prone to toppling over (depending on the book) for the same reasons. Advantageously, the invention addresses these limitations in the prior art and also provides a way to releasably secure a cover over an opening into a container.

In both FIGS. 1 and 2, the exemplary book-clock system 10 is standing on the flat surface 12. In FIG. 1, the front cover 14 and the back cover 16 are closed about the pages 18 of the book 20, but in FIG. 2, the back cover 16 is left open with the pages fanned out a bit. Advantageously, the invention allows a user to choose to display the book-clock system 10 on a flat surface 12 in either of the manners shown in FIG. 1 or in FIG. 2. Of course, the user may choose to display the book-clock system 10 in other ways such as mounted on a wall or other structure, leaning against an object, lying on its back cover 16, etc.

Besides allowing a user to choose between the manners of display shown in FIGS. 1 and 2, there is at least another advantage offered by the invention with respect to display. That advantage is of allowing a book ordinarily incapable of being displayed standing vertically, such as a thin book, to be used in a book-clock system and to be displayed standing vertically. The elements of the invention may add structure and support or otherwise allow for the vertical standing display of a thinner book especially with the opportunity provided by the exemplary embodiment of the invention to allow the end user to open the back cover and fan out the pages to provide a larger base for the book-clock system to stand upon.

As its name informs, the exemplary book-clock system 10 shown in the figures includes a book 20 and a clock 22. The book 20 used in the book-clock system 10 may be almost any book that is a set of sheets or pages bound together between a front cover and a back cover. Typically, such a book-clock system 10 would use a hard cover book. For example, a children's book might be used so the children's book would be displayed with a clock on its front cover as part of the décor of a nursery or a child's room. Nonetheless, a paperback or other type of book may be used as part of a book-clock system according to the invention.

As shown in the figures, the book 20 used in the exemplary book-clock system 10 has a particular size in height, width, depth, number of pages, thickness of covers 14, 16, with respect to the clock hands 24, 26, and 28 of the clock 20 as well in other regards to the system 10. But the size of a book, a clock, or their elements used in alternative embodiments of the invention may vary from what is shown in the figures and from each other. The size and disposition of the elements of the exemplary book-clock system 10 are not to be limiting. In other words, an alternative embodiment may use a thicker book in that there are more pages in the book, another alternative embodiment may use a taller book, and yet another embodiment may use a clock with only two hands, which are sized and positioned differently than shown in the figures.

The book 20 in the exemplary book-clock system 10 has a front cover 14 that is solid in that there are no openings in the front cover 14 other than the hole 30 through which the clock shaft 32 of the clock 22 passes to support and move the clock hands 24, 26, and 28. Another embodiment may have an opening(s) in the front cover so as to show the interior of the book or otherwise.

Instead of an actual book, a “faux” book may be used in embodiments of the invention. A faux book is something that appears to be a book, but is different in some aspect such as lacking pages. Some faux books lacking pages are used for storage of things in the cavity that otherwise would hold the pages.

Again, the invention is not to be limited to the use of a book, as noted previously, but other items may be substituted for the function carried out by the book in the invention. For example, a book substitute may include a box, a can, a container, a holder, a receptacle, a repository, a vessel, or the like.

The clock 22 used in the exemplary book-clock system 10 is an analog clock, but a digital clock may be used in an alternative embodiment, or used in addition to the analog clock in another alternative embodiment. FIGS. 1 and 2 show the hour hand 24, the minute hand 26, and the second hand 28 of the clock 22 displayed on the front cover 14 of the book 20 of the book-clock system 10. The other parts of the clock 22 are not shown in FIGS. 1 and 2 because they are housed within the book 20, which is not shown in FIGS. 1 and 2.

In exemplary embodiment 10, the clock hands 24, 26, and 28 are shown positioned approximately in the middle of the front cover 14 of the book 20. The clock hands in other embodiments may be positioned differently. As an example, in another embodiment, the clock hands 24, 26, and 28 may be positioned in the upper left hand corner. If a front cover includes text or graphics, yet another alternative embodiment may position the clock hands 24, 26, and 28 in a way to compliment such text or graphics or at least not to detract from, interfere with, or obscure text or graphics depicted on the front cover of the embodiment.

The exemplary book-clock system 10 displays only one set of clock hands 24, 26, and 28. Other embodiments may display one or more sets of clock hands. For example, an alternative embodiment may have a first clock showing the time in a user's location, and a second clock showing the time in another location, such as a loved one's location. If more than one clock is used in an alternative embodiment, then each clock may require its own clock movement and other elements. Also, in alternative embodiments, the clock hands may be sized differently with respect to the book cover and book and with respect to each other than shown in the figures. In addition, an alternative embodiment may use only the hour hand, or only the hour hand and the minute hand, while yet another embodiment may use clock hands in addition to the three shown in connection with the book-clock system 10.

The exemplary book-clock system 10 shown in the figures positions the clock hands 24, 26, and 28 on what Western readers consider to be the front cover 14 of the book 20 in that Western readers turn the pages of a book from right to left. An alternative embodiment may position the clock hands on what Western readers consider to be the back cover of a book, especially if the book is written in Chinese, Japanese, Korean, or in a language or manner in which the pages of the book are turned from the left to the right. Yet another alternative of the invention may position the clock hands on the spine of the book.

As with the book 20 in the exemplary embodiment 10 of the invention, other embodiments of the invention are not to be limited to a clock. Other embodiments may include another device(s) alone or with a clock. For example, an exemplary embodiment may display the phases of the moon on a book. As another example, an exemplary embodiment may display weather related items such as a temperature gauge, barometric measure gauge, etc.

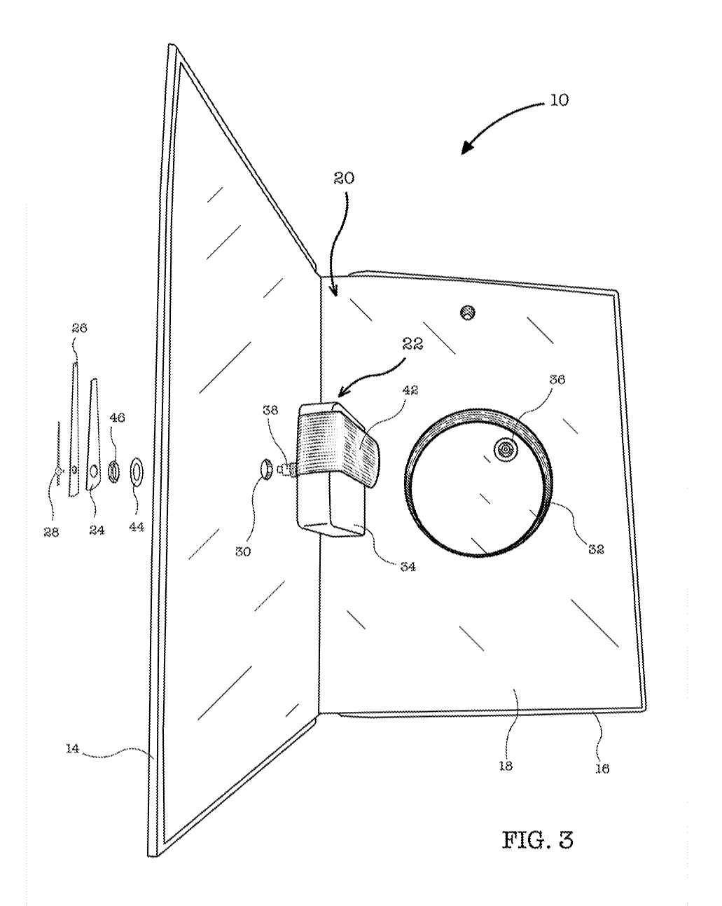

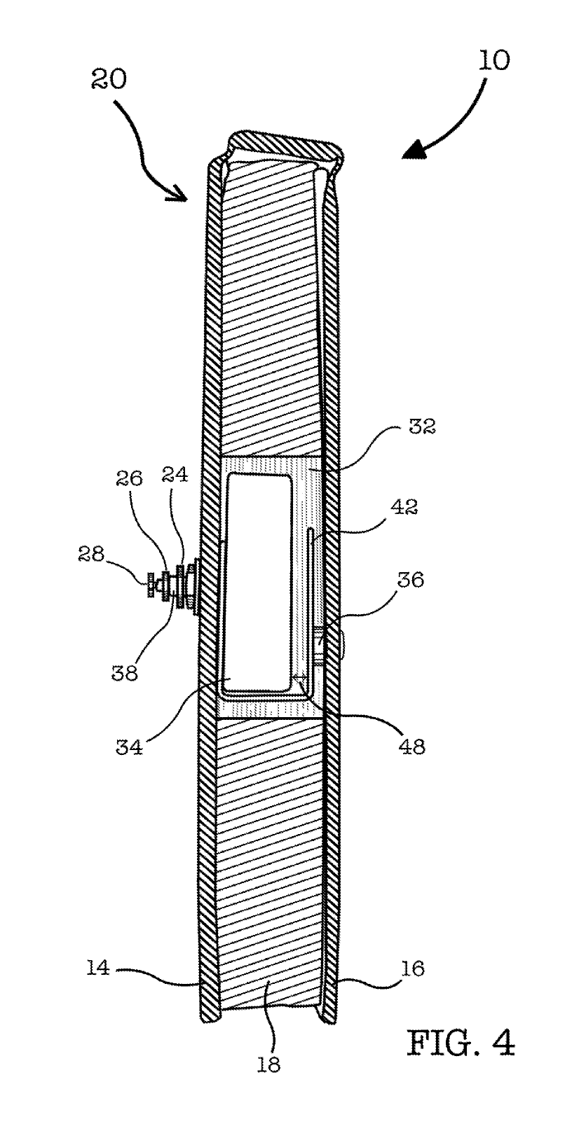

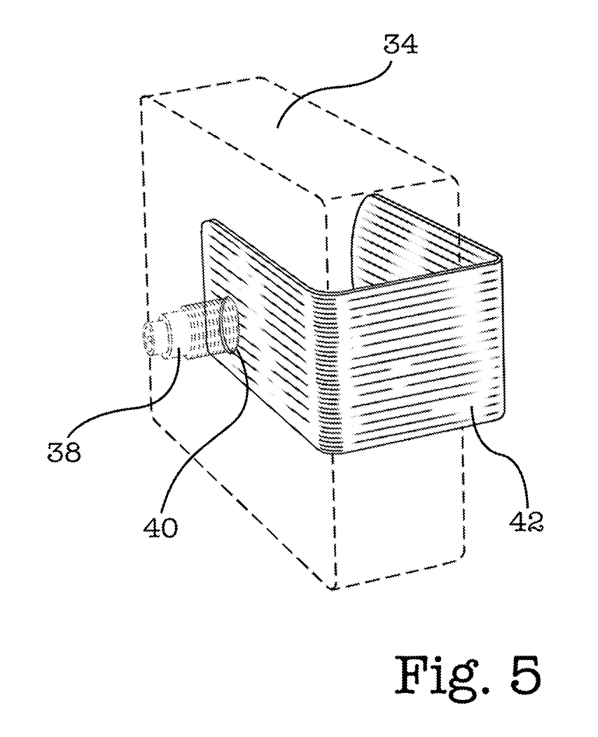

FIGS. 3, 4 and 5 illustrate additional details relating to the exemplary book-clock system 10 shown in FIGS. 1 and 2. FIG. 3 is an exploded view of the elements of the book-clock system 10 while FIG. 4 is a top partial cut-away view of the book-clock system 10. FIG. 5 features the relationship of the clock movement 34, clock shaft 38, and the fastener 42 in of the exemplary embodiment 10.

FIG. 3 shows the exemplary book-clock system 10 with the front cover 14 of the book 20 opened, and the pages 18 lying on top of the back cover 16. A space 32 is hollowed out of the pages 18 of the book 20. The space 32 houses at least the clock movement 34 of the clock 22 of the book-clock system 10. The cutaway view of FIG. 4 shows how the clock movement 34 may be housed within the space 32 when the book covers 14, 16 are closed.

As noted, in the exemplary embodiment 10, the space 32 hollowed in the pages 18 is sized so as to house or contain the clock movement 34. In other embodiments, the space through the pages may be sized to accommodate more than just a clock movement. For example, the space through the pages may allow for storage of small items such as jewelry or valuables for hiding or safekeeping purposes.

In the exemplary embodiment 10, the space 32 is hollowed through all of the pages 18 of the book 20, but that may differ in alternative embodiments depending on the feature(s) of the fastening system. As is explained below, in the exemplary embodiment 10, a magnet 36 on the back cover 16 of the book 20 meets a (at least partially) ferromagnetic fastener 42 that is disposed within the space 32 in the pages 18 of the book 20 when the back cover 16 is closed. The magnetic force between the magnet 36 and the fastener 42 holds the back cover 16 releasably shut. In an alternative embodiment, some pages of the pages of a book may remain whole so long as the magnetic force between the magnet and the fastener is sufficient to releasably hold the back cover shut. Yet other embodiments that do not use a magnet to hold the back cover releasably shut may allow for some of the pages of the book to remain whole.

Also in the exemplary embodiment, the space 32 is shaped generally as a tube through the pages 18 of the book 20, but that also may differ in an alternative embodiment. Further, the space 32 is positioned in about the middle or center of the pages 18 of the book 20. Other embodiments may differ depending on the configuration of other element(s) in the embodiment.

In the exemplary embodiment 10, the space 32 hollowed through the pages 18 of the book 20 defines a generally circular area on the inside of the back cover 16 of the book 20. A magnet 36 is positioned at about the one o'clock position within the circular area defined by the space 32 on the inside of the back cover 16 of the book 20. This positioning may vary in other embodiments depending on the configuration of the elements of those embodiments. As may be seen in FIGS. 3 and 4, the magnet 36 is positioned on the back cover 16 so the magnet 36 is moved within the space 32 hollowed through the pages 18 of the book 20 when the back cover 16 is closed. In the space 32, the magnet 36 meets at least part of the fastener 42 as further described below.

In the exemplary embodiment, the magnet 36 is a countersunk neodymium disc magnet available from CMS Magnetics. This magnet measures about ½″ in diameter and ⅛″ in thickness and is made of a grade N45 neodymium, iron, and boron magnetic alloy blend. This magnetic blend is patent licensed and made under the ISO 9001 quality systems. The magnets are plated in a nickel-copper-nickel coating for a shiny corrosion-resistant finish. The North and South poles are on the flat sides. The pull force of this magnet is 5.25 lbs. This magnet also features a #6 countersunk hole for a flathead screw.

The exemplary book-clock system 10 uses a magnet 36 as explained above. The invention, however, should not be limited to a magnet or magnetic closure system. Alternative embodiments may employ other elements. For example, a hook-and-eye fastener system such as VELCRO® may be used in an alternative embodiment.

The clock 22 of the exemplary book-clock system 10 includes a clock movement 34 with a clock shaft 38. Of course, other ways of implementing a clock may be used. The clock movement 34 used in the exemplary book-clock system 10 is by Quartex, but another brand is Takane. A quartz clock is a clock that uses an electronic oscillator that is regulated by a quartz crystal to keep time. This crystal oscillator creates a signal with very precise frequency, so that quartz clocks are at least an order of magnitude more accurate than mechanical clocks.

The clock movement 34 is positioned behind the front cover 14 and fits within the space 32 hollowed through the pages 18 of the book 20 in the exemplary book-clock system 10. The exemplary clock movement 34 is housed within a generally rectangular box, but other embodiments may vary so long as the clock movement fits within the space in the pages of the book.

A clock shaft 38 is operationally connected to the clock movement 34 of the clock 22 of the exemplary book-clock system 10. In the exemplary embodiment 10, the clock shaft 38 protrudes from about the center of the front of the clock movement 34. The front of the clock movement 34 is that part that faces the front cover 14 of the book 20. Thus, the clock shaft 38 also is positioned to face the front cover 14 of the book 20 of the exemplary book-clock system 10.

The clock shaft 38 is generally cylindrical and is shaped to support hands 24, 26, and 28 of the clock 22 on the outside of the front cover 16 of the book 20. Moreover, the clock shaft 38 generally translates the clock movement's operation to cause the clock hands 24, 26, and 28 to move.

As may be more particularly seen in FIG. 5, as part of the assembly of the elements of the exemplary system 10, the clock shaft 38 is threaded through an opening 40 near one end of a fastener 42. The clock shaft 38 then is passed through the hole 30 in the front cover 14 of the book 20. Thus, the end of the fastener 42 having the opening 40 through which the clock shaft 28 passes is positioned between the inside front cover 14 of the book 20 and the front of the clock movement 34 when the elements of the exemplary embodiment 10 are put together.

Once the clock shaft 28 is passed through the hole 30 in the front cover 14 of the book 20, the clock shaft 28 may be loaded with the elements that are disposed on the outside front cover 14 of the book 20. A washer 44 may be threaded onto the clock shaft 28 followed by a hex nut 46, and then the clock hands 24, 26, 28, which may be capped by a cap nut (not shown in the figures).

Reference is now made again to the fastener 42 in the interior of the book 20. As noted, the clock shaft 38 is passed through the opening 40 near one end of the fastener 42. Once the clock shaft 38 is passed through the opening 40, the fastener 42 may be bent or curved as needed to continue around a side of the clock movement 34. As best seen in FIG. 4, the fastener 42 may be wrapped from the front of the clock movement 34 around a side of the clock movement 34 so the fastener 42 is in fairly close proximity to the side about which the fastener 42 is wrapped. Other embodiments may vary.

From the side of the clock movement 34, the fastener 42 may be bent or curved around the back of the clock movement 34. In the exemplary embodiment 10, the result of the positioning of the fastener 42 is that the end of the fastener 42 opposite to the end with the opening 40 is at least adjacent to the back of the clock movement 34. In other words, the fastener 42 may be formed into a substantially U shape about the clock movement 34 with one end of the fastener 42 having an opening 40 through which the clock shaft 38 passes and another end or part of the fastener 42 being adjacent to the back of the clock movement 34. “Adjacent” as used herein may include directly next to the back of the clock movement 34 or spaced apart from it as is explained below.

A fastener also may be referred to as a fastening element herein. In the exemplary embodiment, the fastener 42 is made from 30 Gauge galvanized sheet metal strapping often used for, and thus referred to as Duct Hanger Strap. It can be purchased in an HVAC supply company and/or Metal Distributor. East Coast Metal Distributors is an example. From a 1″ or 1½″ wide roll of 30 gauge galvanized sheet metal, an exemplary fastener may be cut into a length, with 8 mm opening in one end, and trimmed to a smooth curved finished. Other embodiments may vary is size, disposition, and other characteristics. For example, in an alternative embodiment, only part (the back part) of the fastener is ferromagnetic.

In the exemplary embodiment 10, there is a distance 48 between the back of the clock movement 34 and the part of the fastener 42 that is adjacent to the back of the clock movement 34, which is referred to herein as the back part of the fastener 42. It is generally parallel along its length in the exemplary embodiment 10 at the distance 48 to the back of the clock movement 34. Other embodiments may vary.

That the back part of the fastener 42 is positioned parallel at the distance 48 from the back of the clock movement 34 is deliberate in the exemplary embodiment 10. At the distance 48, at least a portion of the back part of the fastener 42 meets the magnet 36 when the back cover 16 of the book 20 is closed. When the back cover 16 is closed, a magnetic force is exerted between the magnet 36 and the portion of the back part of the fastener 42 so the back cover 16 is held releasably closed about the book 20. The back cover 16 is held releasably closed because a force may be exerted on the back cover 16 to overcome the magnetic force between the magnet 36 and the fastener 42 and draw the back cover 16 away from the pages 18 of the book 20.

According to the invention, there is an advantage to positioning the back part of the fastener at a distance from the back of the clock movement. The positioning of the back part of the fastener 42 at the distance 48 from the back of the clock movement 34 in the exemplary embodiment 10 takes into account that the depth of the clock movement 34 is not as deep as the pages 18 of the book 20. The distance 48 makes up for the clock movement 34 not being as deep as the pages 18 of the book 20. The distance 48 allows the back of the fastener 42 to meet up with the magnet 36 when the back cover 16 of the book 20 is closed. If the back part of the fastener 42 is positioned on or directly adjacent to the back of the clock movement 34, the magnet 36 would not meet up with the fastener 42 when the back cover 16 of the book 20 was closed. No fastening of the back cover 16 of the book 20 would take place. Thus, the positioning of the back part of the fastener 42 at the distance 48 allows the magnet 36 and fastener 42 to meet and for the magnetic force therebetween to releasably secure the back cover 16 of the book 20 in the exemplary embodiment 10.

As used in the exemplary embodiment 10, there are advantages to the fastener 42 being a flexible strip and at least partially (on the back part) ferromagnetic. One advantage is that the fastener 42 is held in place in the exemplary embodiment 10 without the need for any extra element or the use of adhesive or glue. As explained above, the fastener 42 has an opening 40 on one end through which the clock shaft 38 is passed before the clock shaft 38 then is passed through the hole 30 in the front cover 14 of the book 20. The clock movement 34 with the fastener 42 wrapped around it is housed within the space 32 hollowed out of the pages 18. Thus, the fastener 42 is held in place without the need for extra elements, adhesives, etc.

There is another advantage of the fastener 42 being a flexible strip at least in embodiments similar to the exemplary embodiment 10. The flexible strip may be relatively easily shaped to extend a distance (such as the distance 48 in the exemplary embodiment 10) adjacent to the back of the clock movement to take into account the varying depths between the clock movement and the pages of the book. For example, a book may be selected to use with an alternative embodiment of the invention with pages not deeper than the depth of the clock movement. In this example, the flexible strip may be adjusted to lie adjacent to the back of the clock movement so the magnet on the back cover meets the flexible strip. As another example, a book may be selected with pages that are deeper than the pages 18 shown in the exemplary embodiment 10. The back part of the flexible strip may be adjusted to a position further distant from the back of the clock movement 34 so the back of the flexible strip may meet with the magnet on the back cover of the book.

In some embodiments, the adjustments to the positioning of the back part of the fastener with respect to the back of the clock movement may require a different positioning of the magnet on the back cover of the book than that of the one o'clock position shown in the exemplary embodiment. The different positions of the magnets may be required so as to meet up with a part of the respective back parts of the fasteners.

As described above, the fastener 42 in the exemplary embodiment 10 is generally U-shaped and wraps around from the front of the clock movement 34 to a position adjacent to the back of the clock movement 34. In the exemplary embodiment 10, the entire fastener 42 is a flexible ferromagnetic strip. An alternative embodiment may use the same U-shaped configuration, but have a fastener where only the back part is ferromagnetic. Other embodiments are possible.

Other embodiments according to the invention may implement the fastener in ways other than the U-shape described with respect to the exemplary embodiment 10. As an example, a ferromagnetic piece of material may be applied directly to the back of the clock movement. As another example, to provide the advantage of the variable positioning of the back part of the flexible strip in the exemplary embodiment, a moveable L-shaped fastener may be used. In this example, one part of the L-shape is the ferromagnetic part that meets with the magnet, and the other part of the L-shape is adjustable with respect to the clock movement to move the ferromagnetic part to the distance required for it to meet the magnet. Other embodiments of the fastener are possible.

### CONCLUSION

The exemplary embodiments of the invention were chosen and described above in order to explain the principles of the invention and its practical applications so as to enable others skilled in the art to utilize the inventions including various embodiments and various modifications as are suited to the particular uses contemplated. The examples provided herein are not intended as limitations of the present invention. Uses with other types of apparatus, devices, items, methods, and/or systems may be appropriate. Other embodiments will suggest themselves to those skilled in the art.

I claim:

1. A book-clock system that keeps the front cover and the back cover of a book selectively closed about the pages of the book, the system comprising:
a clock movement housed within a space hollowed through the pages of the book;
a clock shaft connected to the clock movement for moving clock hands according to the clock movement,
the clock shaft protruding from the clock movement for passing through a hole in the front cover of the book, and
the clock shaft supporting the clock hands on the outside of the front cover of the book; and
a fastening element having an opening near one end for passing the clock shaft through the fastening element prior to the clock shaft being passed through the hole in the front cover of the book so the end of the fastening element with the opening is positioned between the front cover of the book and the clock movement,
the fastening element being positioned about the clock movement so at least a part of the fastening element is adjacent to a portion of the clock movement facing the back cover of the book, and
at least the part of the fastening element adjacent to the portion of the clock movement facing the back cover of the book being ferromagnetic;
a magnet positioned on the back cover of the book so when the back cover is closed, the magnet meets the ferromagnetic part of the fastening element and a magnetic force is exerted between the magnet and the ferromagnetic part of the fastening element,
whereby the magnetic force between the magnet and the ferromagnetic part of the fastening element holds the back cover of the book closed unless the back cover of the book is opened forcibly enough to overcome the magnetic force.

2. The system of claim 1, wherein the fastening element is substantially entirely ferromagnetic.

3. The system of claim 1, wherein the fastening element is supported between the front cover of the book and the clock movement at least in part by the clock shaft.

4. The system of claim 1, wherein the fastening element comprises a flexible ferromagnetic strip.

5. The system of claim 1, wherein the fastening element assumes a U-shape about the clock movement.

6. An apparatus to releasably secure a cover over an opening in a container used to display time, the apparatus comprising:
a clock movement housed inside the container;
a clock shaft operationally connected to the clock movement,
the clock shaft protruding from the clock movement,
the clock shaft passing through the container to an outside part of the container used as a clock face,
the clock shaft supporting clock hands on the clock face, and
the clock shaft moving the clock hands according to the clock movement;
the container having an opening to provide access to the clock movement;
a ferromagnetic element disposed in the access opening of the container;
a magnet disposed on the cover so the magnet is aligned with the ferromagnetic element in the access opening of the container when the cover is placed over the access opening,
whereby the alignment of the magnet and the ferromagnetic element creates a magnetic force that releasably secures the cover over the access opening of the container.

7. The system of claim 6, wherein the fastening element comprises a flexible ferromagnetic strip.

8. A fastener system for releasably securing a cover over a container opening, the fastener system comprising:
a ferromagnetic element disposed in the container opening; and
a magnet positioned on the cover so the magnet meets the ferromagnetic element when the cover is closed over the container opening,
whereby closing the cover over the container opening creates a magnetic force between the magnet and the ferromagnetic element to releasably secure the cover over the container opening.
